(19) United States
(12) Patent Application Publication
(10) Pub. No.: US 2018/0130069 A1
(43) Pub. Date: May 10, 2018

(54) PREVENTING WRITING SUPPORT EMAILS USING ANALYTICS

(71) Applicant: CA, Inc., New York, NY (US)

(72) Inventors: Dwibhashyam V S CHAITANYA, Hyderabad (IN); Sravan Phani Kumar VIDIYALA, Hyderabad (IN); Surya Kiran SATYAVARAPU, Hyderabad (IN); Gowtham Sen POTNURU, Hyderabad (IN); Shaik MOKHINUDDEEN, Hyderabad (IN)

(73) Assignee: CA, Inc.

(21) Appl. No.: 15/346,045

(22) Filed: Nov. 8, 2016

(51) Int. Cl. G06Q 30/00; G06F 17/21; G06F 17/27

(52) U.S. Cl. CPC G06Q 30/016; G06F 17/2705; G06F 17/211

(57) ABSTRACT

A method includes determining that a user is initiating a support ticket based on an intended recipient of information input by the user into a support portal application on a user device, wherein the intended recipient is a technical support consultant of an enterprise associated with the user. The method further includes determining a candidate problem statement based on analysis of information input, the candidate problem statement identifying a technical issue that the user is likely describing in information input by the user. In addition, the method includes determining a set of potential solutions to the technical issue by comparing, using the processor, the candidate problem statement to a plurality of past problem statements that are each associated with at least one respective solution. Further, the method includes formatting each of the potential solutions for display in the support portal application on the user device prior to creating the support ticket.

### BACKGROUND

The present disclosure relates to providing potential solutions based on contextual analysis, and, more specifically, to systems and methods for analyzing input information to match a candidate problem statement with a potential solution.

Customer support systems are often inundated with repeat customer issues. Responding to each customer issue requires significant resources and oftentimes leaves the customer mired in a problem until receiving a response. This process diminishes the customer experience when seeking support and is contrary to many organizations' goal of providing the highest customer satisfaction possible.

Systems and methods described herein provide a system with the ability to provide support recommendations to the customer or end user during the request process. The present disclosure describes a system and method for analyzing information input by a user into an application on a user device. The system may determine a candidate problem statement identifying a technical issue based on analysis of information input. Further, the system may determine a set of potential solutions to the technical issue by comparing the candidate problem statement to a plurality of past problem statements that are each associated with at least one solution. The system may format each of the potential solutions for display in the application on the user device.

### BRIEF SUMMARY

According to an aspect of the present disclosure, a method may include several processes. In particular, the method may include determining that a user is initiating a support ticket based on an intended recipient of information input by the user into a support portal application on a user device, wherein the intended recipient is a technical support consultant of an enterprise associated with the user. The method may further include determining a candidate problem statement based on analysis of information input, the candidate problem statement identifying a technical issue that the user is likely describing in the information input to the application. The method may further include determining a set of potential solutions to the technical issue by comparing, using the processor, the candidate problem statement to a plurality of past problem statements that are each associated with at least one solution. Further, the method may include formatting, using the processor, each of the potential solutions for display in the application on the user device.

Other features and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements of a non-limiting embodiment of the present disclosure.

FIG. 1 is a schematic representation of an analysis engine ecosystem of a non-limiting embodiment of the present disclosure.

FIG. 2 is a schematic representation of an analysis engine configured to interact with the analysis engine ecosystem.

FIG. 3 illustrates a support portal application supported by the analysis engine according to a non-limiting embodiment of the present disclosure.

FIG. 4 illustrates a flow chart of the analysis engine according to a non-limiting embodiment of the present disclosure.

FIG. 5 is a flow chart for a method for analyzing user input and determining a set of potential solutions according to a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. Each activity in the present disclosure may be executed on one, some, or all of one or more processors. In some non-limiting embodiments of the present disclosure, different activities may be executed on different processors.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to customer service solutions in support portal applications, systems and methods disclosed herein may be related to any field. Moreover, certain examples disclosed herein may be described with respect to consumer or business solutions, or any other field that may involve user input. Certain embodiments described in the present disclosure are merely provided as example implementations of the processes described herein.

Whenever a customer has an issue in a support portal application, the customer's first step is typically to send an email to a support team or submit a support ticket describing the issue. Support consultants often interact directly with the customer via the support portal application and other advanced support systems such as, for example, CA Service Desk, ZenDesk, and or BMC Remedy. These interactions consume support service resources and the customer is often in limbo until the issue is resolved.

Systems and methods disclosed herein aim to increase customer satisfaction and conserve support service resources by automatically providing possible resolutions based on contextual information of the user's input. Systems and methods disclosed herein may analyze information input by a user into a support portal application on a user device. This analysis may occur in real-time. In addition, the systems and methods disclosed herein may improve computer function quickly if a user requests the analysis engine 30 to implement a potential solution. Systems and methods disclosed herein may further determine a candidate problem statement based on analysis of information input, wherein the candidate problem statement identifies a technical issue that the user is likely describing in the information input to the support portal application. Systems and methods disclosed herein may determine a set of potential solutions to the technical issue by comparing the candidate problem statement to a plurality of past problem statements that are each associated with at least one solution. Further, systems and methods disclosed herein may format each of the potential solutions for display in the support portal application on the user device.

The teachings of the present disclosure may reference specific example “device.” For example, an “device” can include may refer to a smartphone, tablet, desktop computer, laptop, Global Positioning System (GPS) device, satellite communication terminal, radio communication terminal, or any other device capable of receiving input. For example, a mobile device may be equipped with a support portal application capable of receiving user input. Any device with such capabilities is contemplated within the scope of the present disclosure.

In a first example, systems and methods disclosed herein may determine, using a processor, that a user is initiating a support ticket based on an intended recipient of information input by the user into a support portal application on a user device, wherein the intended recipient is a technical support consultant of an enterprise associated with the user. Systems and methods disclosed herein may further determine, using the processor, a candidate problem statement based on analysis of information input, the candidate problem statement identifying a technical issue that the user is likely describing in information input by the user. In addition, systems and methods disclosed herein may determine a set of potential solutions to the technical issue by comparing, using the processor, the candidate problem statement to a plurality of past problem statements that are each associated with at least one respective solution. Systems and methods disclosed herein may also format, using the processor, each of the potential solutions for display in the application on the user device prior to creating the support ticket.

In a second example, non-limiting embodiments of the present disclosure may include a computer configured to access a storage device, the computer comprising a processor and a non-transitory, computer-readable storage medium storing computer-readable instructions that when executed by the processor cause the computer to perform determining that a user is initiating a support ticket based on an intended recipient of information input by the user into a support portal application on a user device, wherein the intended recipient is a technical support consultant of an enterprise associated with the user. Further, the processing system may be configured to perform processes including determining a candidate problem statement based on analysis of information input, the candidate problem statement identifying a technical issue that the user is likely describing in the information input by the user. In addition, the processing system may be configured to perform processes including determining a set of potential solutions to the technical issue by comparing the candidate problem statement to a plurality of past problem statements that are each associated with at least one respective solution. Further, the processing system may be configured to perform processes including formatting each of the potential solutions for display in the support portal application on the user device prior to creating the support ticket. The processing system may also be configured to perform processes including formatting a feedback inquiry for display in the support portal application prior to creating the support ticket, the feedback inquiry requesting user input for accuracy of at least one potential solution.

In a third example, systems and methods disclosed herein may determine that a user is initiating a support ticket based on an intended recipient of information input by the user into an email application on a user device, wherein the intended recipient is a technical support consultant of an enterprise associated with the user. Systems and methods disclosed herein may also determine a candidate problem statement based on analysis of information input, the candidate problem statement identifying a technical issue that the user is likely describing in the information input by the user. Further, systems and methods disclosed herein may determine a set of potential solutions to the technical issue by comparing the candidate problem statement to a plurality of past problem statements that are each associated with at least one respective solution. In addition, systems and methods disclosed herein may store the candidate problem statement and at least one potential solution in a database on the user device, the database storing the plurality of past problem statements and respective solutions. Further, systems and methods disclosed herein may format each of the potential solutions for display in the email application on the user device prior to creating the support ticket.

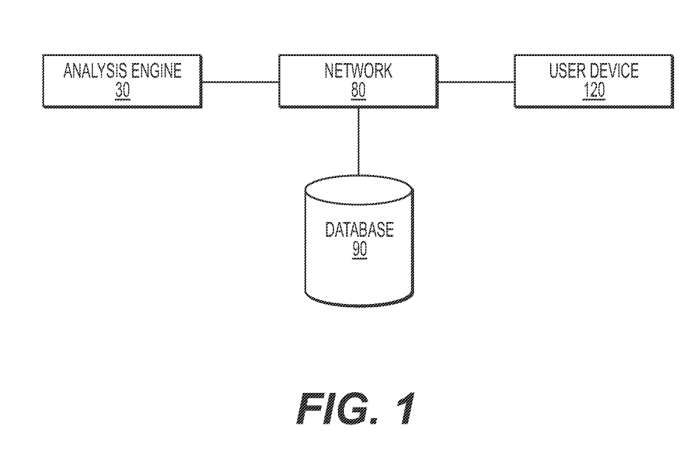

Referring now to FIG. 1, an analysis engine ecosystem of a non-limiting embodiment of the present disclosure is illustrated. An analysis engine 30 may communicate with a database 90 and user device 120 via a network 80. In addition, analysis engine 30 may directly communicate with user device 120 when analysis engine 30 is installed on the user device 120.

Network 80 may comprise one or more entities, which may be public, private, or community based. Network 80 may permit the exchange of information and services among users/entities that are connected to such network 80. In certain configurations, network 80 may be a local area network, such as an intranet. Further, network 80 may be a closed and/or private network/cloud in certain configurations, and an open network/cloud in other configurations. Network 80 may facilitate wired or wireless communications of information and provisioning of services among users that are connected to network 80.

Network 80 may comprise one or more clouds, which may be public clouds, private clouds, or community clouds. Each cloud may permit the exchange of information and the provisioning of services among devices and/or applications that are connected to such clouds. Network 80 may include a wide area network, such as the Internet; a local area network, such as an intranet; a cellular network, such as a network using CDMA, GSM, 3G, 4G, LTE, or other protocols; a machine-to-machine network, such as a network using the MQTT protocol; another type of network; or some combination of the aforementioned networks. Network 80 may be a closed, private network, an open network, or some combination thereof and may facilitate wired or wireless communications of information among devices and/or applications connected thereto.

Network 80 may include a plurality of devices, which may be physical devices, virtual devices (e.g., applications running on physical devices that function similarly to one or more physical device), or some combination thereof. The devices within network 80 may include, for example, one or more of general purpose computing devices, specialized computing devices, mobile devices, wired devices, wireless devices, passive devices, routers, switches, mainframe devices, monitoring devices, infrastructure devices, other devices configured to provide information to and/or receive information from service providers and users, and software implementations of such.

In some non-limiting embodiments of the present disclosure, user device 120 may be a mobile device such as a mobile phone, laptop, tablet, any portable device, etc. Mobile electronic devices may be part of a communication network such as a local area network, wide area network, cellular network, the Internet, or any other suitable network. Mobile devices may be powered by a mobile operating system, such as Apple Inc.'s iOS® mobile operating system or Google Inc.'s Android® mobile operating system, for example. A mobile electronic device may use a communication network to communicate with other electronic devices, for example, to access remotely-stored data, access remote processing power, access remote displays, provide locally-stored data, provide local processing power, or provide access to local displays. For example, networks may provide communication paths and links to servers, which may host applications, content, and services that may be accessed or utilized by users via mobile electronic devices. The content may include text, video data, audio data, user settings or other types of data. Networks may use any suitable communication protocol or technology to facilitate communication between mobile electronic devices, such as, for example, BLUETOOTH, IEEE WI-FI (802.11a/b/g/n/ac), or Transmission Control Protocol/Internet Protocol (TCP/IP).

In addition, analysis engine 30 may use network 80 to communicate with a user device 120. In some non-limiting embodiments of the present disclosure, user device 120 may communicate with analysis engine 30 via network 80. In some non-limiting embodiments of the present disclosure, analysis engine 30 may be located on user device 120 associated with a user. In some non-limiting embodiments, user device 120 may communicate with analysis engine 30 using a cellular network, such as 3G or LTE, for example, or other communication protocols or methods, such as Wi-Fi or NFC, for example. Further, user device 120 may include one or more applications that provide a user interface, which may display alerts, alarms, and/or notifications associated with analysis engine 30 disclosed herein, and which may provide one or more options for interaction with analysis engine 30.

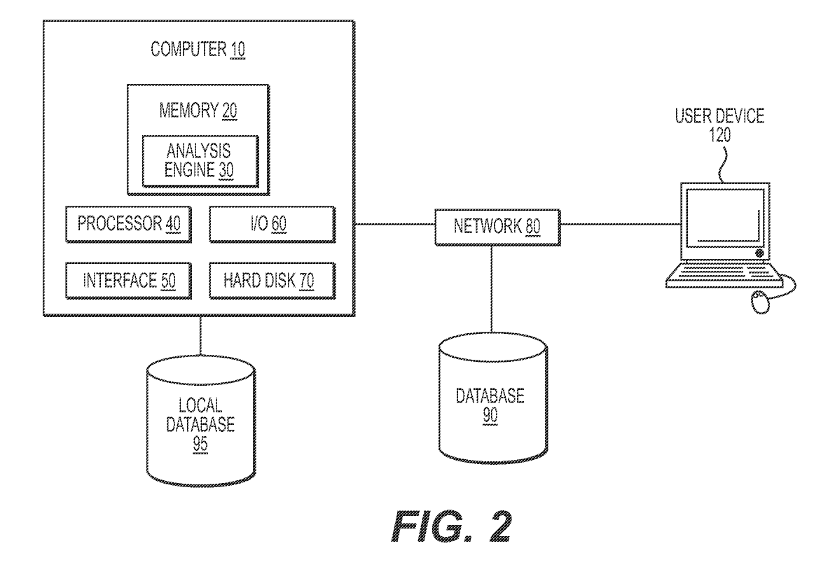

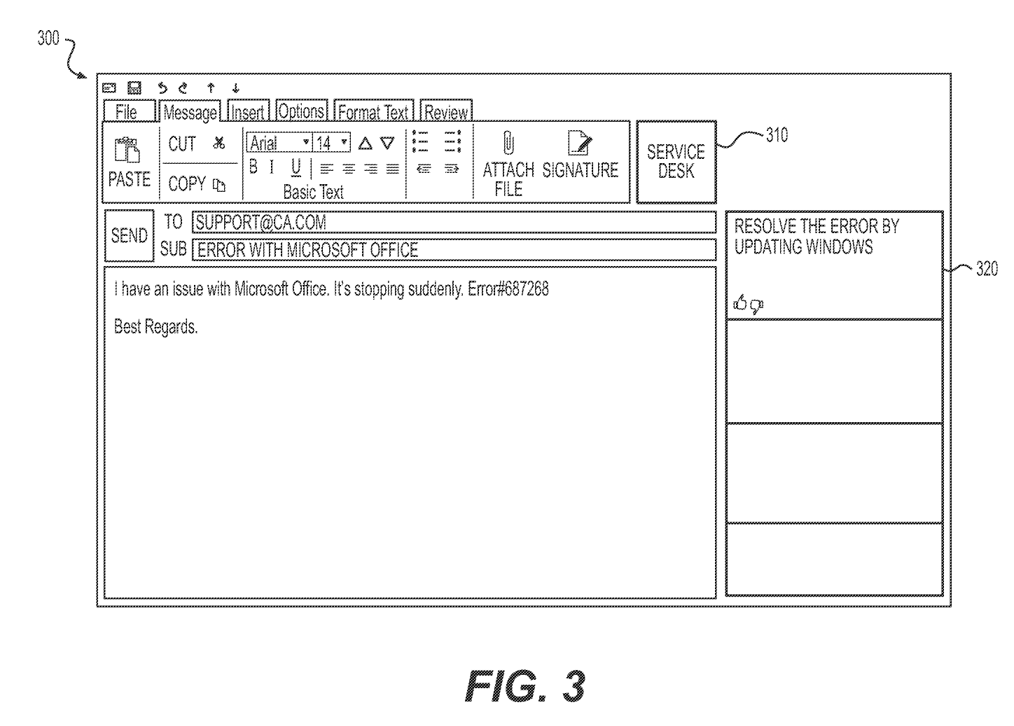

Referring to FIG. 2, the analysis engine 30 of a non-limiting embodiment of the present disclosure is displayed. Computer 10 may reside on one or more networks. In some non-limiting embodiments, computer 10 may be located on any device that may receive input from a device, such as, for example, a mobile device or user device 120. Computer 10 may comprise a memory 20, a central processing unit, an input and output (“I/O”) device 60, a processor 40, an interface 50, and a hard disk 70. Memory 20 may store computer-readable instructions that may instruct mobile device 10 to perform certain processes. In particular, memory 20 may store a plurality of application programs that are under development. Memory 20 also may store a plurality of scripts that include one or more testing processes for evaluation of applications or input. When computer-readable instructions, such as an application program or a script, are executed by the CPU, the computer-readable instructions stored in memory 20 may instruct the CPU to perform a plurality of functions. Examples of such functions are described below with respect to FIGS. 3-5. In some non-limiting embodiments of the present disclosure, the CPU may be analysis engine 30. In some implementations, when computer-readable instructions, such as an application program or a script, are executed by the CPU, the computer-readable instructions stored in memory 20 may instruct the analysis engine 30 to perform analysis of user input. In some non-limiting embodiments, Computer 10 may be located on the user device 120, on a remote server, on the cloud, or any combination thereof. In some non-limiting embodiments, Computer 10 and analysis engine 30 communicate with user device 120 via network 80.

The analysis engine 30 environment may also include a database 90 and local database 95. Both database 90 and local database 95 may include, for example, additional servers, data storage, and resources. Analysis engine 30 may receive additional data, candidate problem statements, text analysis, potential solutions, or any data used by analysis engine 30 from database 90 and/or local database 95. Both database 90 and local database 95 may be any conventional database or data infrastructure. For example, database 90 may include scaled out data architectures (i.e., Apache Hadoop) and/or persistent, immutable stores/logging systems.

I/O device 60 may receive data from network 80, local database 95, database 90, data from other devices and sensors connected to analysis engine 30, and input from a user and provide such information to the analysis engine 30. I/O device 60 may transmit data to network 80, database 90, and/or a local database. I/O device 60 may transmit data to other devices connected to analysis engine 30, and may transmit information to a user (e.g., display the information, send an e-mail, make a sound). Further, I/O device 60 may implement one or more of wireless and wired communication between user device 120 or analysis engine 30 and other devices within or external to network 80. I/O device 60 may receive one or more of data from another server or a network 80. The analysis engine 30 may be a processing system, a server, a plurality of servers, or any combination thereof. In addition, I/O device 60 may communicate received input or data from user device 120 to analysis engine 30.

Analysis engine 30 may be located on the cloud or on an external network. Analysis engine 30 may be SaaS or entirely located on the mobile device 10. In some non-limiting embodiments, analysis engine 30 may be partially located on a mobile device and partially on the cloud or a network, or any combination thereof. Furthermore, some non-limiting configurations of analysis engine 30 may be located exclusively on a user device 120, such as, for example a mobile device or tablet. Analysis engine 30 may also be accessed by a user on user device 120. User device 120 may be any type of computing device, for example, a mobile telephone or a tablet.

Further referring to FIG. 2, in some non-limiting embodiments of the present disclosure, a mobile application may be installed on the user device 120. The mobile application may facilitate communication with analysis engine 30, database 90, local database 95, or any other entity. In some non-limiting embodiments, a program on user device 120 may track, record, and report input information to the analysis engine 30, such as, for example, text. The program may be a support portal application. In systems and methods of the present disclosure, such as when the analysis engine 30 is located on user device 120, user device 120 may not be connected to network 80 while in communication with analysis engine 30.

In some non-limiting embodiments, user device 120 may store analysis data, input, candidate problem statements, potential solutions, and any other data associated with the analysis engine 30 locally on the user device 120. In some non-limiting embodiments of the present disclosure, a support portal application may communicate with analysis engine 30 to manage analysis, data, and corresponding user input on the user device 120. The support portal application and analysis engine 30 may maintain an offline copy of all information. In some non-limiting embodiments of the present disclosure, in which the analysis engine 30 is located completely on user device 120, analysis engine 30 may complete text analysis and determination of potential solutions without a connection to network 80. In such situations, analysis engine 30 may rely on information stored locally on user device 120. In some systems and methods of the present disclosure, analysis engine 30 may rely on information in a cloud database. In such embodiments, analysis engine 30 may require updates to more effectively analyze candidate problem statements.

In some non-limiting embodiments, system diagnostics of user device 120 may be communicated to analysis engine 30 and considered when determining a candidate problem statement. Analysis engine 30 may consider processing bandwidth, memory usage, hardware usage, program usage, software, performance, network status, resource usage, etc. of user device 120 in analyzing information input and determining candidate problem statements and potential solutions.

Analysis engine 30 may consider any contextual data of user device 120 or any other devices connected to network 80. In some non-limiting embodiments, analysis engine 30 may consider communications in support portal applications by other computers within an enterprise. For example, in analyzing information input into a support portal application of a user device 120, analysis engine 30 may consider other computers within an enterprise that have similar information input or similar computer system diagnostics. In addition, analysis engine 30 may consider the time and date of previous submissions, spikes in submissions of a certain type, data of other users such as their position in an enterprise, contextual data related to other reported issues, or any other data associated with interactions of the analysis engine 30 and other computer systems.

FIG. 3 illustrates a support portal application supported by the analysis engine according to a non-limiting embodiment of the present disclosure. Analysis engine 30 may overlay any functions on top of the support portal application. For example, analysis engine 30 may overlay a service desk button 310 such that users on the user device 120 may more easily interact with analysis engine 30. In some non-limiting embodiments of the present disclosure, the support portal application 300 may be an email client such as Microsoft Outlook® or Google Mail®. Support portal application 300 may also be any program in which a user may input data. In some non-limiting embodiments of the present disclosure, the support portal application 300 may be an application or program in which a use may submit a support ticket seeking assistance from a technical support consultant of an enterprise associated with the user. The technical consultant may be a third party consultant with access to communications within an enterprise associated with the user.

As depicted in FIG. 3, analysis engine 30 may analyze, using a processor, information input by a user into an application on user device 120. For example, a user has input “SUPPORT@CA.COM” in the TO field, “ERROR WITH MICROSOFT OFFICE” in the SUBJECT field, and additional comments in the BODY field of the message. In some non-limiting embodiments of the present disclosure, analysis engine 30 may analyze the recipient(s) of the email to determine a topic at issue. For example, analysis engine 30 may determine that because the user has entered “SUPPORT@CA.COM” in the TO field, the user likely will need assistance regarding a technical issue with a CA product or, if the user is internal, with internal IT systems. In addition, analysis engine 30 may analyze the user input into the SUBJECT field to further determine the technical issue at hand. For example, because a user has entered “ERROR WITH MICROSOFT OFFICE” in the SUBJECT field, analysis engine 30 may determine that the technical issue involves Microsoft Office® and may accordingly limit suggested potential solutions.

FIG. 3 represents a non-limiting embodiment of the present disclosure; analysis engine 30 may analyze any input from a user into the support portal application, such as into a CC or BCC field. Furthermore, analysis engine 30 may analyze any text in the support portal application that is not input in real-time by the user. For example, analysis engine 30 may analyze text included from a previous correspondence in the BODY field of an email, such as is a user forwards an email to explain the issue. In addition, analysis engine 30 may analyze symbols, images, and video input by the user to determine a candidate problem statement. In some non-limiting embodiments, analysis engine 30 may use text tools such as character recognition of an image in order to accurately conduct analysis.

In some non-limiting embodiments of the present disclosure, analysis engine 30 may consider all user input individually and in combination to more accurately determine a candidate problem statement. Analysis may occur in real-time as a user enters input. In some non-limiting embodiments of the present disclosure, analysis engine 30 may perform analysis each time the support portal application 300 receives an input. In some non-limiting embodiments of the present disclosure, the analysis engine 30 may be configured to display potential solutions and recommendations when sufficient information is input into the support portal application 300. For example, the analysis engine 30 may begin analysis when ten text characters are entered into the BODY field in a support portal application 300. In other non-limiting embodiments, analysis engine 30 may initiate analysis upon receiving input into the TO and SUBJECT fields of the support portal application 300.

Analysis engine 30 may determine a candidate problem statement based on the analysis of user input. In some non-limiting embodiments, analysis engine 30 may identify a technical issue that the user is likely describing in the input to the support portal application 300, and develop the candidate problem statement according to the technical issue. In some non-limiting embodiments, the candidate problem statement may abstractly represent a technical issue determined from the user input into the support portal application 300. In addition, the analysis engine may determine the candidate problem statement based on all user input, including input in the TO and SUBJECT fields. Furthermore, analysis engine 30 may rely on other information on the support portal application 300, such as names and contents of attachments and text previously entered into the input fields (e.g., if an email is forwarded by the user).

In some non-limiting embodiments of the present disclosure, analysis engine 30 may determine a set of potential solutions to the technical issue by comparing the candidate problem statement to a plurality of past problem statements that are each associated with at least one solution. In addition, analysis engine may format each of the potential solutions for display in a solution window 320 in the support portal application 300 on the user device 120. Analysis engine 30 may have a database of past problem statements and corresponding solutions. The database may be supported or developed by technical support employees to bolster the abilities of the analysis engine 30. In addition, the database of past problem statements and corresponding solutions may be adapted according to the effectiveness of suggested solutions and user feedback. User feedback may be input in any manner, such as, for example, clicking a ‘thumbs up’ icon or a ‘thumbs down’ icon in the solution window 320. Analysis engine 30 may utilize user feedback to calibrate the effectiveness of potential solutions corresponding to the candidate problem statement. In some non-limiting embodiments of the present disclosure, analysis engine may display multiple solution windows in the support portal application 300.

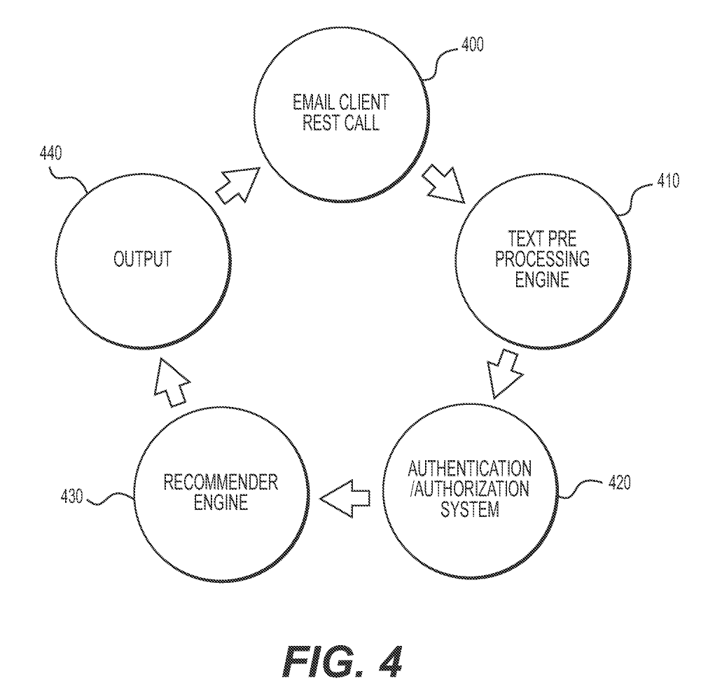

FIG. 4 illustrates a flow chart of the analysis engine according to a non-limiting embodiment of the present disclosure. The flow chart details actions of the analysis engine 30 of some non-limiting embodiments and interactions between the support portal application 300 and the analysis engine 30.

The email client plugin 400 may be the main customer end-point solution. As the user inputs data into the support portal application 300, analysis engine 30 may analyze the input data. In some non-limiting embodiments of the present disclosure, the analysis engine 30 may analyze user input upon the user clicking the service desk button 310. Upon clicking the service desk button 310, the email client plugin 400 may send a REST call to the text parsing and pre-processing engine 410. Email client plugin 400 may communicate with text parsing and pre-processing engine 410 in any other manner.

The text parsing and pre-processing engine 410 may parse the text and input in order for the analysis engine 30 to more efficiently analyze the input. The text parsing and pre-processing engine 410 may strip away additional information and words using rule based logic. For example, text parsing and pre-processing engine 410 may utilize a stop word list in order to determine important words for analysis. In some non-limiting embodiments, text parsing and pre-processing engine 410 may parse the input to remove unnecessary words. In some non-limiting embodiments, the text parsing and pre-processing engine 410 may perform any type of text pre-processing or text mining techniques, such as, for example, stemming and lemmatization. The text parsing and pre-processing engine 410 may send processed data to the authentication and authorization system 420 to determine if the user has authority to access data and analysis of the analysis engine 30.

The authentication and authorization system 420 may check to see if the user inputting information has the authorization to access certain data. For example, if the user lacks authorization to view potential solutions, candidate problem statements, past problem statements, or any other data regarding analysis engine 30, the authentication and authorization system 420 may prevent the information from being displayed to the user in the support portal application 300. If the authentication and authorization system 420 determines that the user has appropriate authorization to view potential solutions, the authentication and authorization system 420 may notify the recommender engine 430.

The recommender engine 430 may utilize similarity based algorithms such as, for example, vector space model, Okapi BMI, Okapi BM25, Okapi BM25F to determine a relevant solution for the problem statement based on analysis of information input. The recommender engine 430 may use any ranking function to rank matching potential solutions to problem statements based on relevance of analyzed input and context. Recommender engine 430 may also consider document structure and anchor text in the analysis. In some non-limiting embodiments when a potential solution is not used by a user or receives low feedback, the recommender engine 430 may store such feedback and adopt its analysis. Further, the recommender engine 430 may track when a potential solution is used in relation to a problem statement and also adopt the analysis accordingly.

The output engine 440 may receive data from the recommender engine 430. Further, the output engine 440 may parse the data into a format that the support portal application can understand and display. In some non-limiting embodiments, the data is sent to an email client plugin. In addition, the output engine 440 may paginate results, potential solutions, candidate problem statements, problem statements, and any other data such that the display may include top N results at a time. In addition, a user of the support portal application 300 may pursue a recommendation or potential solution by selecting a displayed reference link for assistance, sending an email to the support team based on level of satisfaction, selecting a reference link to an instructional manual, etc. In some non-limiting embodiments of the present disclosure, users may select an action to initiate the recommendation or potential solution on the user device 120. The recommendation or potential solution may be implemented by the support portal application or by the analysis engine 30.

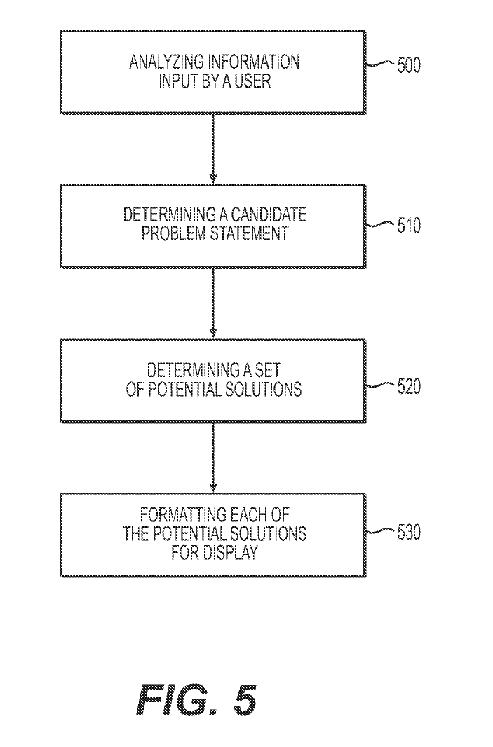

FIG. 5 is a flow chart for a method for analyzing user input and determining a set of potential solutions according to a non-limiting embodiment of the present disclosure. In step 500, analysis engine 30 may analyze information input by a user into a support portal application 300 on a user device 120. The support portal application 300 may be an email client, a support portal application, or an application for internal use at an enterprise. In some non-limiting embodiments analysis may be performed each time the support portal application 300 receives input. In some non-limiting embodiments, such as when there is contextual information previously input into support portal application 300, the contextual information may be analyzed prior to any input from a user. Contextual information may include information input into a support portal application 300 as well as system diagnostics of user device 120.

In some non-limiting embodiments of the present disclosure, analysis engine 30 may determine that a user is initiating a support ticket based on an intended recipient of information input by the user into an application, wherein the intended recipient is associated with a support staff of an enterprise. Information input by a user into the support portal application 300 on a user device 120 may include an email address entry, a subject line entry, and a body entry.

In step 510, analysis engine 30 may determine a candidate problem statement based on analysis of input information, wherein the candidate problem statement may identify a technical issue that the user is likely describing in the information input to the support portal application 300. In some non-limiting embodiments, the candidate problem statement may identify an issue of any subject, such as a question about mathematics or nature. The type of information analyzed by the analysis engine 30 is not limited to current user input. For example, the information may include email addresses to technical support, previously entered information, information from a previous email string, attachments, font, images, videos, calendar appointments within a predetermined time frame of user entry, and any other data in a support portal application 30 or in an email client. Analysis engine 30 may apply pre-defined rules to the information input by the user by using at least one of stop word removal, stemming, and lemmatization.

In step 520, analysis engine 30 may determine a set of potential solutions to the technical issue by comparing the candidate problem statement to a plurality of past problem statements that are each associated with at least one solution. The plurality of past problem statements and corresponding solutions may be developed by support representatives continually developing analysis engine 30. In some non-limiting embodiments, a past problem statement may have multiple solutions. The analysis engine 30 may compare the candidate problem statement to past problem statements to determine similarities in technical issues and whether or not corresponding solutions may apply to the candidate problem statement. Further, analysis engine 30 may store the candidate problem statement and at least one potential solution in a database on the user device 120. In some non-limiting embodiments of the present disclosure, the database may store the plurality of past problem statements and respective solutions.

In step 530, analysis engine 30 may format each of the potential solutions for display in the support portal application 300 on the user device. Analysis engine 30 may also display optional feedback mechanisms to gauge accuracy of potential solutions and recommendations. In some non-limiting embodiments, the feedback inquiry may request user input to indicate accuracy of at least one potential solution. Further, analysis engine 30 may display each of the potential solutions while the user is inputting information into the support portal application 300 on the user device 120. In other words, the analysis engine 30 may perform analysis and display potential solutions in real-time in the support portal application 300. For example, analysis engine 30 may provide recommendations and potential solutions to a user in the support portal application 300 while the user is writing an email. In some non-limiting embodiments of the present disclosure, analysis engine 30 may display each of a plurality of potential solutions prior to the submission of the information input by the user. In some cases, submission of the information may occur by sending an email or submitting a support ticket in a support portal application.

Further, analysis engine 30 may display an option for the user to request the analysis engine 30 to implement a potential solution. In some non-limiting embodiments of the present disclosure, analysis engine 30 may present a reference link option to the user in the support portal application 300 such that the user may click on for more information or to proceed to a troubleshooting or instructional manual. For example, analysis engine 30 may format a reference link to a troubleshooting or instruction manual for display in the support portal application 300 on the user device 120.

In some non-limiting embodiments, analysis engine 30 may, upon displaying at least one of the potential solutions, prevent the user from inputting information into the support portal application 300. For example, analysis engine 30 may prevent the user from inputting information in order to force the user to acknowledge the potential solutions determined based on the user's input. In some non-limiting embodiments, the analysis engine 30 may prevent the user from submitting information input by the user into the support portal application. For example, analysis engine 30 may prevent the use from submitting a support ticket, sending an email, or any other feature of a support portal application 300. The analysis engine 30 may receive feedback indicating that the potential solution does not match the actual problem the user is trying to convey, and the analysis engine 30 may then return to the user access to all features in the support portal application 300. In some non-limiting embodiments, the analysis engine 30 may deny the user access to features of the support portal application 300 until the user provides feedback on potential solutions, for example.

The flowcharts and diagrams in FIGS. 1-5 illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, “each” means “each and every” or “each of a subset of every,” unless context clearly indicates otherwise.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

What is claimed is:

1. A method, comprising:
determining, using a processor, that a user is initiating a support ticket based on an intended recipient of information input by the user into an application, wherein the intended recipient is associated with a support staff of an enterprise;
determining, using the processor, a candidate problem statement based on the information input by the user, the candidate problem statement identifying a technical issue that the user is likely describing;
determining a set of potential solutions to the technical issue by comparing, using the processor, the candidate problem statement to a plurality of past problem statements that are each associated with at least one respective solution; and
formatting, using the processor, each of the potential solutions for display in the application before creating the support ticket.

2. The method of claim 1, wherein formatting, using the processor, each of the potential solutions for display in the application comprises:
displaying, using the processor, each of the potential solutions while the user is inputting information into the application.

3. The method of claim 1, wherein the information input by the user comprises an email address associated with the support staff.

4. The method of claim 1, wherein each potential solution is associated with resolving a respective technical issue described by the associated past problem statement within the enterprise.

5. The method of claim 1, wherein determining the candidate problem statement comprises:
determining system diagnostics of a device running the application.

6. The method of claim 1, further comprising:
storing the candidate problem statement and at least one potential solution in a database on the user device, the database storing the plurality of past problem statements and respective solutions.

7. The method of claim 1, wherein the application is an email application.

8. The method of claim 1, wherein formatting, using the processor, each of the potential solutions for display in the application comprises:
formatting, using the processor, a feedback inquiry for display in a support portal application, the feedback inquiry requesting user input for accuracy of at least one potential solution.

9. The method of claim 1, wherein formatting, using the processor, each of the potential solutions for display in the application comprises:
formatting for display, using the processor, a reference link to a troubleshooting manual for each of the potential solutions.

10. The method of claim 1, wherein determining, using the processor, the candidate problem statement comprises:
applying pre-defined rules to the information by using stop word removal.

11. The method of claim 1, wherein determining, using the processor, the candidate problem statement comprises:
applying pre-defined rules to the information by using stemming.

12. The method of claim 1, wherein determining, using the processor, the candidate problem statement comprises:
applying pre-defined rules to the information by using lemmatization.

13. A computer configured to access a storage device, the computer comprising:
a processor; and
a non-transitory, computer-readable storage medium storing computer-readable instructions that when executed by the processor cause the computer to perform:
determining that a user is initiating a support ticket based on an intended recipient of information input by the user into a support portal application on a user device, wherein the intended recipient is a technical support consultant of an enterprise associated with the user;
determining a candidate problem statement based on analysis of information input, the candidate problem statement identifying a technical issue that the user is likely describing in the information input by the user;
determining a set of potential solutions to the technical issue by comparing the candidate problem statement to a plurality of past problem statements that are each associated with at least one respective solution; and
formatting each of the potential solutions for display in the support portal application on the user device prior to creating the support ticket; and
formatting a feedback inquiry for display in the support portal application prior to creating the support ticket, the feedback inquiry requesting user input for accuracy of at least one potential solution.

14. The computer of claim 13, wherein the computer-readable instructions further cause the computer to perform:
displaying at least one of the potential solutions in the support portal application; and
upon displaying at least one of the potential solutions:
preventing the user from inputting information into the support portal application.

15. The computer of claim 13, wherein formatting each of the potential solutions for display in the support portal application on the user device prior to creating the support ticket comprises:
formatting, for each of the potential solutions, a reference link to a troubleshooting manual for display in the support portal application on the user device.

16. The computer of claim 13, wherein formatting each of the potential solutions for display in the support portal application on the user device prior to creating the support ticket comprises:
displaying each of the potential solutions prior to the submission of the information input by the user.

17. The computer of claim 13, wherein the information input by the user into the support portal application on the user device comprises a subject line entry and a body entry.

18. The computer of claim 13, wherein the computer-readable instructions further cause the computer to perform:
displaying at least one of the potential solutions in the support portal application; and
upon displaying at least one of the potential solutions:
preventing the user from creating the support ticket based on the information input by the user into the support portal application.

19. The computer of claim 1, wherein determining a candidate problem statement based on analysis of information input comprises:
applying pre-defined rules to the information by using stemming.

20. A non-transitory computer-readable medium having instructions stored thereon that are executable by a computing system to perform operations comprising:
determining that a user is initiating a support ticket based on an intended recipient of information input by the user into an email application on a user device, wherein the intended recipient is a technical support consultant of an enterprise associated with the user;
determining a candidate problem statement based on analysis of information input, the candidate problem statement identifying a technical issue that the user is likely describing in the information input by the user;
determining a set of potential solutions to the technical issue by comparing the candidate problem statement to a plurality of past problem statements that are each associated with at least one respective solution;
storing the candidate problem statement and at least one potential solution in a database on the user device, the database storing the plurality of past problem statements and respective solutions; and
formatting each of the potential solutions for display in the email application on the user device prior to creating the support ticket.
